(19) United States
(12) Patent Application Publication
(10) Pub. No.: US 2020/0285693 A1
(43) Pub. Date: Sep. 10, 2020

(54) MANAGEMENT DEVICE, MANAGEMENT SYSTEM, AND NON-TRANSITORY COMPUTER READABLE MEDIUM

(71) Applicant: FUJI XEROX CO., LTD., Tokyo (JP)

(72) Inventor: Yoshiaki HATANO, Kanagawa (JP)

(73) Assignee: FUJI XEROX CO., LTD., Tokyo (JP)

(21) Appl. No.: 16/559,026

(22) Filed: Sep. 3, 2019

(30) Foreign Application Priority Data
Mar. 4, 2019 (JP) 2019-038581

(51) Int. Cl. G06F 17/24; G06F 17/27

(52) U.S. Cl. CPC G06F 17/243; G06F 17/241; G06F 17/2725; G06F 17/248

(57) ABSTRACT

A management device includes an acquirer and a shifting controller. The acquirer acquires, in a subject job step included in multiple job steps, a response document or an instruction to change a setting of a format used for exchanging documents in the subject job step. A request is made and a response to the request is returned as a result of exchanging documents in each job step. The response document is used as the response. The shifting controller performs control to shift the subject job step to another job step in accordance with a condition concerning a change in the setting based on the instruction or a condition concerning content of the response document.

### CROSS-REFERENCE TO RELATED APPLICATIONS

This application is based on and claims priority under 35 USC 119 from Japanese Patent Application No. 2019-038581 filed Mar. 4, 2019.

### BACKGROUND

### (i) Technical Field

The present disclosure relates to a management device, a management system, and a non-transitory computer readable medium.

### (ii) Related Art

A technology for managing document exchange is known. Japanese Unexamined Patent Application Publication No. H05-191448, for example, discloses a technology for automatically determining a sending route of a document to be sent by email in accordance with the type of email. Japanese Unexamined Patent Application Publication No. H11-282859, for example, discloses a technology for determining where to send a received communication document in accordance with the classification of text of the received communication document.

### SUMMARY

A job constituted by multiple job steps may be carried out by exchanging documents in the following manner. When sending a document to a receiver, a sender may request the receiver to edit or check the document. In this case, the receiver edits or checks the document and may return the editing or checking result to the sender as a response to the request. After exchanging documents in this manner, a certain job step proceeds to the next job step. After executing the multiple job steps in this way, the job is completed. In each step, before proceeding to another step, a job operator is required to check the content of a response to a request and to determine whether a condition for proceeding to another step is satisfied. This takes a lot of time and effort for the job operator.

Aspects of non-limiting embodiments of the present disclosure relate to a technology which is used to carry out multiple job steps, a request being made and a response to the request being returned as a result of exchanging documents in each job step, and which is used for shifting a subject job step to another job step according to whether a condition for shifting the subject job step to another job step is satisfied without intervention of a job operator.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a management device including an acquirer and a shifting controller. The acquirer acquires, in a subject job step included in multiple job steps, a response document or an instruction to change a setting of a format used for exchanging documents in the subject job step. A request is made and a response to the request is returned as a result of exchanging documents in each job step. The response document is used as the response. The shifting controller performs control to shift the subject job step to another job step in accordance with a condition concerning a change in the setting based on the instruction or a condition concerning content of the response document.

### BRIEF DESCRIPTION OF THE DRAWINGS

An exemplary embodiment of the present disclosure will be described in detail based on the following figures, wherein:

FIG. 1 is a schematic diagram illustrating an example of the configuration of a management system according to the exemplary embodiment;

FIG. 2 is a diagram illustrating an example of a series of job steps forming a job;

FIG. 3 is a block diagram illustrating an example of the hardware configuration of a management device;

FIG. 4 illustrates an example of a setting table indicating a format used for exchanging documents in each job step;

FIG. 5 is a block diagram illustrating an example of the functional configuration of the management device;

FIGS. 6A and 6B illustrate examples of condition tables;

FIG. 7 illustrates an example of a management screen;

FIG. 8 illustrates an example of a questionnaire;

FIG. 9 is a sequence chart illustrating an example of processing executed by the management system; and

FIG. 10 is a flowchart illustrating an example of processing executed by the management device.

### DETAILED DESCRIPTION

### 1. Configuration

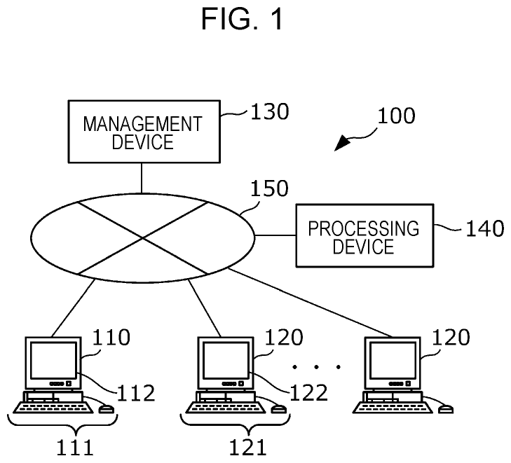

FIG. 1 illustrates an example of the configuration of a management system 100 according to an exemplary embodiment. The management system 100 is used for exchanging documents between a user or a device that makes a request (hereinafter may also simply be called a requester) and a user or a device that undertakes a job in response to the request (hereinafter may also simply be called a request executor). The management system 100 includes a request terminal 110, plural receiving terminals 120, a management device 130, and a processing device 140. These devices are connected to each other via a communication network 150. The communication network 150 relays communication between these devices. An example of the communication network 150 is the Internet.

The request terminal 110 is a device used by a requester to exchange data with the management device 130. Examples of the request terminal 110 are small computers, such as a personal computer (PC), a tablet terminal, and a smartphone. A requester is in charge of various jobs. Each job is constituted by plural job steps. In each job step, a request is made and a response to the request is returned. The requester requests a person or a device to do certain work concerning each job step. Making a request refers to sending a document concerning certain work to request a person or a device to do this work. A document is digital data that can be processed by a computer. A document is not restricted to a document described in characters, but may be any type of data if it indicates information.

The receiving terminals 120 are devices used by receivers to exchange data with the management device 130. Examples of the receiving terminals 120 are small computers, such as a PC, a tablet terminal, and a smartphone. Hereinafter, the receiving terminals 120 may collectively be called the receiving terminal 120 unless it is necessary to individually distinguish them from each other. A receiver receives a request made by a requester and does certain work concerning the request, and then responds to the request by sending the result. Responding to a request refers to sending a result of doing work concerning the request by using a document. Making a request by a requester and returning a response by a receiver are performed by exchanging documents between the request terminal 110 and the receiving terminal 120.

The management device 130 manages exchanging of documents between the request terminal 110 and the receiving terminal 120. More specifically, the management device 130 relays exchanging of documents by storing a document sent from one of the request terminal 110 and the receiving terminal 120 and by sending the document to the other one of the request terminal 110 and the receiving terminal 120. As the management device 130, a cloud server, for example, may be used. The processing device 140 executes various processing operations in response to a request from a requester and responds to the request by sending the processing result. As the processing device 140, a server, for example, may be used.

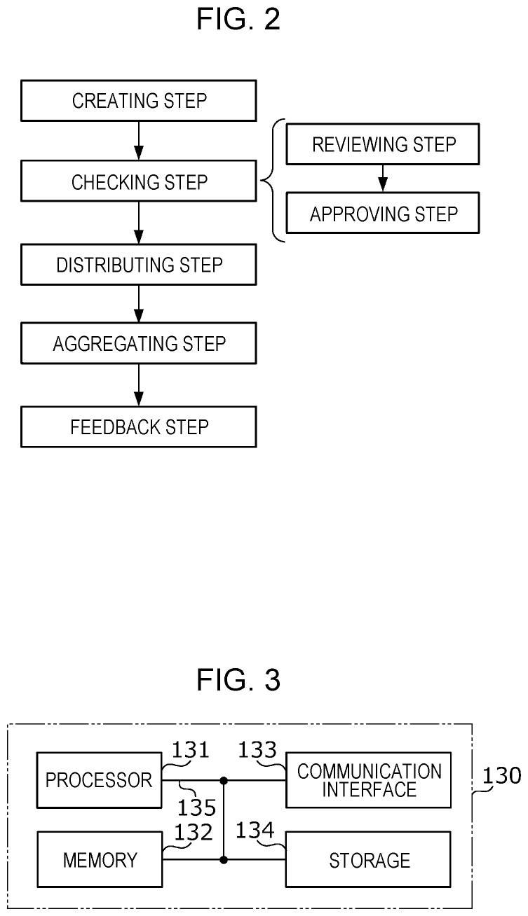

FIG. 2 is a diagram illustrating an example of a series of job steps forming a job. The job includes a creating step, a checking step, a distributing step, an aggregating step, and a feedback step. The checking step includes a reviewing step and an approving step. These steps are executed in a predetermined order. In this example, the creating step, reviewing step, approving step, distributing step, aggregating step, and feedback step are executed in this order. In the creating step, a document draft related to a certain job is created. In the reviewing step, the document draft created in the creating step is reviewed. In the approving step, the document draft subjected to the reviewing step is approved. In the distributing step, the document approved in the approving step is distributed. In the aggregating step, responses to the document distributed in the distributing step are aggregated. In the feedback step, feedback on the aggregation result obtained in the aggregating step is provided if necessary. In each job step, a request is made and a response to the request is returned. The format for exchanging documents to make a request and to return a response to the request is fixed.

FIG. 3 illustrates an example of the hardware configuration of the management device 130. The management device 130 includes a processor 131, a memory 132, a communication interface 133, and a storage 134. These elements are connected to each other via a bus 135. The processor 131 controls the individual elements of the management device 130 and processes data or a program. An example of the processor 131 is a central processing unit (CPU). The memory 132 is a computer-readable recording medium which is also called a primary storage device, and stores a program or data processed by the processor 131. As the memory 132, a read only memory (ROM) and a random access memory (RAM) may be used. The communication interface 133 is connected to the communication network 150 and performs data communication via the communication network 150. The storage 134 is a computer-readable recording medium which is also called an auxiliary storage device, and stores various programs and data. As the storage 134, a hard disk drive or a solid state drive may be used. In the storage 134, a request folder 235 and a response folder 236, which will be discussed later, are stored in advance.

Referring back to FIG. 1, the request terminal 110 includes an operation unit 111 and a display 112, in addition to the elements of the above-described management device 130. The operation unit 111 receives an operation performed by a requester on the request terminal 110. As the operation unit 111, a keyboard and a mouse, operation keys, or a touchscreen, for example, may be used. The display 112 displays various items of information. As the display 112, a liquid crystal display or an organic electroluminescence (EL) display, for example, may be used. The receiving terminal 120 includes an operation unit 121 and a display 122, in addition to the elements of the above-described management device 130. The operation unit 121 and the display 122 are similar to the operation unit 111 and the display 112, respectively, of the request terminal 110. The configuration of the processing device 140 is similar to that of the management device 130.

Access to the management device 130 is restricted. Basically, users and devices other than those registered in the management device 130 are unable to access the management device 130 from an external source. It is now assumed that a requester is a registered user or device, while a receiver is not a registered user and the processing device 140 is not a registered device. In this case, even if the requester makes a request by using a request document and stores it in the management device 130, the receiver or the processing device 140 is unable to access the management device 130 to obtain the request document. However, if the requester specifies the receiver or the processing device 140 and permits it to download the request document, the receiver or the processing device 140 is able to access the management device 130 and obtain the request document. If the requester specifies the receiver or the processing device 140 and permits it to upload a response document, the receiver or the processing device 140 is able to access the management device 130 and store a response document in the management device 130. The receiver or the processing device 140 being permitted to download a request document and to upload a response document by the requester is set to be a request executor in a corresponding job step.

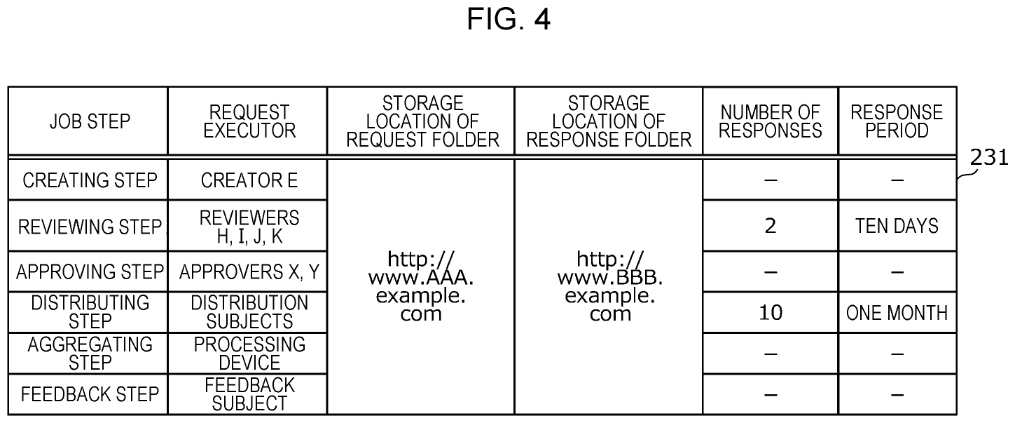

FIG. 4 illustrates an example of a setting table 231 indicating a format used for exchanging documents in each job step. The setting table 231 is stored in the storage 134 in advance. The setting table 231 has items of information: a request executor, a storage location of the request folder 235, a storage location of the response folder 236, the number of responses, and a response period according to each job step. These items of information are used as settings of the format for exchanging documents. The format is a predetermined approach to exchanging documents. The format for exchanging documents refers to, not only the format for sending and receiving documents, but also the format for storing documents while the documents are being exchanged.

A request executor is a subject which undertakes a job in response to a request and which has already been permitted to download and upload documents by a requester. Examples of the subject are a receiver using the receiving terminal 120 and the processing device 140. If the subject is a receiver using the receiving terminal 120, an email address of the receiver may be used as the request executor. If the subject is the processing device 140, a communication address of the processing device 140 may be used as the request executor. The request executor may be a single subject or multiple subjects. The storage location of the request folder 235 is a location in which a request document is stored. The storage location of the response folder 236 is a location in which a response document is stored. The request folder 235 and the response folder 236 are accessible from an external source. These storage locations may be expressed by uniform resource locators (URLs). The number of responses is a predetermined minimal number of responses. The response period is a predetermined period within which a response is required to be returned.

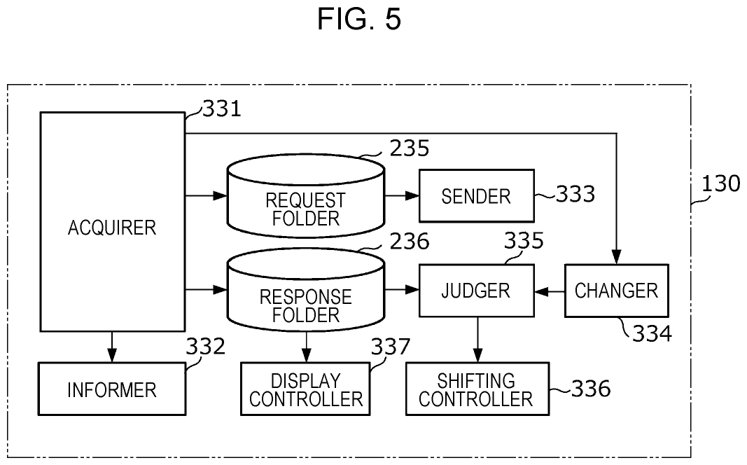

FIG. 5 illustrates an example of the functional configuration of the management device 130. The management device 130 functions as an acquirer 331, an informer 332, a sender 333, a changer 334, a judger 335, a shifting controller 336, and a display controller 337. These functions are implemented as a result of the processor 131 computing or controlling communication made by the communication interface 133 in cooperation with a program stored in the memory 132 and the processor 131 executing the program.

When a request document for making a request is sent from the request terminal 110 in accordance with a requester operation, the acquirer 331 acquires this request document. When a response document for making a response is sent from the receiving terminal 120 in accordance with a receiver operation or from the processing device 140, the acquirer 331 acquires this response document. When an instruction to change a setting of the format for exchanging documents in a job step which is currently executed (hereinafter such a job step will be called a subject job step) is sent from the request terminal 110 in accordance with a requester operation, the acquirer 331 acquires this instruction. The request document and the response document acquired by the acquirer 331 are stored in the request folder 235 and the response folder 236, respectively. The instruction acquired by the acquirer 331 is supplied to the changer 334.

When a request document is stored in the request folder 235, the informer 332 notifies the receiving terminal 120 or the processing device 140 of the storage location of the request document and that of a response document. When a response document is stored in the response folder 236, the informer 332 notifies the request terminal 110 that a response is returned. The informer 332 may supply the above-described items of information by sending an email or notification information to the request terminal 110 and the receiving terminal 120 or the processing device 140 or by displaying a message on a screen of the request terminal 110 and that of the receiving terminal 120.

In response to access to the storage location of a request document by the receiving terminal 120 or the processing device 140, the sender 333 sends the request document stored in the request folder 235 to the receiving terminal 120 or the processing device 140. That is, the sender 333 sends a request document by using pull-type communication.

When the acquirer 331 has acquired an instruction to change a setting, the changer 334 changes the corresponding setting included in the setting table 231 in accordance with this instruction. The changer 334 supplies the content of a change made in the setting to the judger 335.

The judger 335 judges whether a condition for shifting a subject job step to another job step is satisfied. There are two types of conditions as this condition. One condition is a return condition concerning a change in a setting of the format for exchanging documents based on an instruction. The other condition is a return condition concerning the content of a response document. The return condition concerning a change in a setting is a condition indicating that a change is made in a setting. This type of return condition is included in a condition table 232. The return condition concerning the content of a response document is a condition indicating that the content of a response document does not conform to the content of a request or that a request document needs changing. This type of return condition is included in a condition table 233.

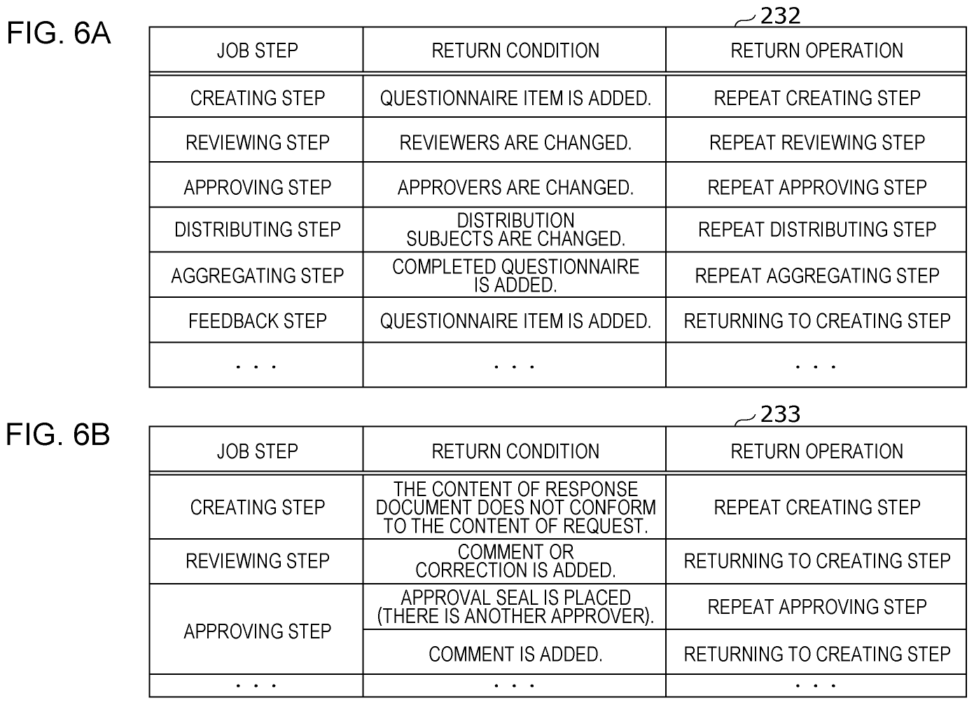

FIGS. 6A and 6B respectively illustrate an example of the condition table 232 and an example of the condition table 233. The condition tables 232 and 233 are stored in the storage 134 in advance. The condition table 232 in FIG. 6A has fields of a return condition concerning a change in a setting and a return operation to be performed when this return condition is satisfied. The condition table 233 in FIG. 6B has fields of a return condition concerning the content of a response document and a return operation to be performed when this return condition is satisfied. In each of the condition tables 232 and 233, the return condition and the corresponding return operation are provided according to each job step. These return operations are operations for making a subject process return to a preceding process in a subject job step or a subject job step return to a preceding job step. The process or step to which the subject process or step returns is determined so that the corresponding return condition is no longer satisfied as a result of performing the corresponding return operation, for example. The judging result of the judger 335 is supplied to the shifting controller 336.

The shifting controller 336 performs control to shift a subject job step to another job step in accordance with a condition for shifting a subject job step to another job step. If a response document does not satisfy a return condition, the shifting controller 336 performs control to shift a subject job step to the next job step. In contrast, if a response document satisfies a return condition, the shifting controller 336 performs control to repeat a subject job step or shift it to a preceding job step. If a return condition concerning a change in a setting is not satisfied, the shifting controller 336 performs control to shift a subject job step to the next job step. In contrast, if a return condition concerning a change in a setting is satisfied, the shifting controller 336 performs control to repeat a subject job step or shift it to a preceding job step. The shifting controller 336 achieves the above-described control operations by switching the setting to be used among the settings in the setting table 231 and by managing exchanging of documents after the setting to be used is switched to the next one. For example, in the case of the creating step, documents are exchanged in accordance with the settings of the creating step described in the setting table 231 in FIG. 4. When the creating step is switched to the reviewing step, the settings of the creating step are switched to those of the reviewing step, and documents are exchanged in accordance with the settings of the reviewing step described in the setting table 231 in FIG. 4.

The display controller 337 performs control to display a response document on the request terminal 110. The display controller 337 also performs control to display on the request terminal 110 the progress situation of a job conducted in accordance with plural job steps and information concerning conditions. The display controller 337 achieves these control operations by sending data for displaying the corresponding information to the request terminal 110. Information to be displayed by the display controller 337 may be included in a management screen 400 displayed on the display 112 of the request terminal 110.

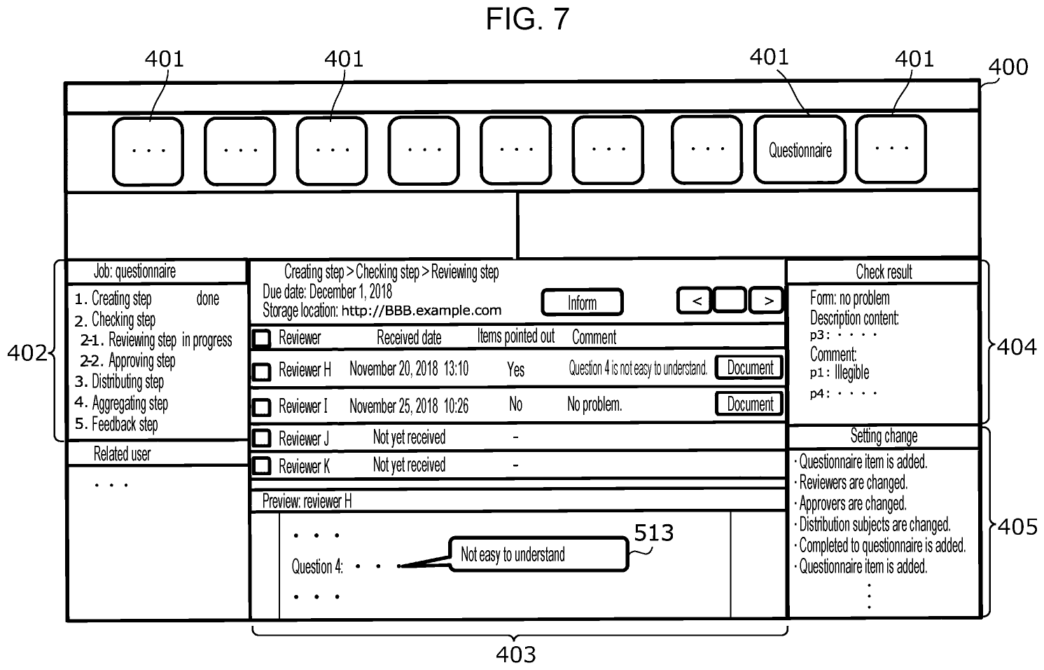

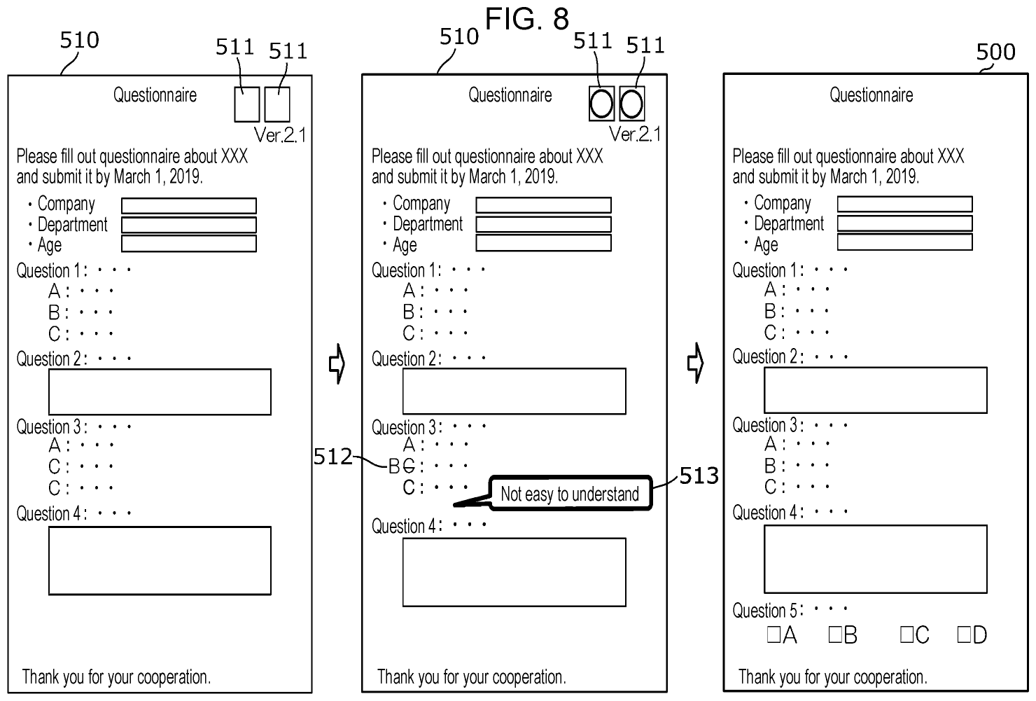

FIG. 7 illustrates an example of the management screen 400. The management screen 400 includes plural manipulation buttons 401 associated with plural predetermined jobs based on a one-to-one correspondence. A requester operates one of the manipulation buttons 401 to select the corresponding job. The management screen 400 includes a display area 402 for job steps. In the display area 402, a list of job steps included in a job selected by the requester and the progress situation of each job step are displayed. In the display area 402, the multiple job steps shown in FIG. 2 are displayed. Among the job steps, if the creating step has been done, the progress situation of the creating step is indicated by “done”, as shown in FIG. 7. While the reviewing step is being carried out, the progress situation of the reviewing step is indicated by “in progress”, as shown in FIG. 7. The management screen 400 also includes a display area 403 for response documents. In the display area 403, the status of a response document indicating whether it has been received, an overview of a response document, and a response document acquired by the acquirer 331 are displayed. The management screen 400 also includes a display area 404 for check results. In the display area 404, the judging result of the judger 335 about the return condition concerning the content of a response document is displayed. The management screen 400 also includes a display area 405 for information concerning a change in a setting. In the display area 405, a list of return conditions concerning a change in each setting included in the condition table 232 shown in FIG. 6A, for example, and the situation concerning a change in a setting are displayed. That is, in the display areas 404 and 405, information directly or indirectly indicating a return condition concerning the content of a response document and a return condition concerning a change in a setting is displayed.

As in the functions of the management device 130, the functions of the request terminal 110, the receiving terminal 120, and the processing device 140 are also implemented as a result of a corresponding processor computing or controlling communication made by a communication interface in cooperation with a program stored in a memory and the processor executing the program.

### 2. Operation

A requester selects a predetermined job by using the corresponding manipulation button 401 displayed on the management screen 400 shown in FIG. 7. To carry out a job concerning a questionnaire 500 shown in FIG. 8, for example, the requester presses the manipulation button 401 corresponding to the questionnaire 500 by using the operation unit 111 of the request terminal 110. Then, a series of job steps forming a job for carrying out the questionnaire 500 is started.

FIG. 8 illustrates an example of the questionnaire 500. In the example of the job steps shown in FIG. 2, a questionnaire draft 510 shown in the left section of FIG. 8 is first created in the creating step. The questionnaire draft 510 includes plural questionnaire items and answer fields, and also includes seal fields 511 for placing approval seals. Then, as shown in the middle section of FIG. 8, the questionnaire draft 510 is reviewed in the reviewing step and is approved in the approving step. The questionnaire 500 is then created based on the approved questionnaire draft 510, as shown in the right section of FIG. 8. Subsequently, in the distributing step, the questionnaire 500 is distributed and responses to the questionnaire 500 are collected. In the aggregating step, the responses to the questionnaire 500 are aggregated. Then, in the feedback step, feedback on the aggregation result of the responses to the questionnaire 500 is provided if necessary.

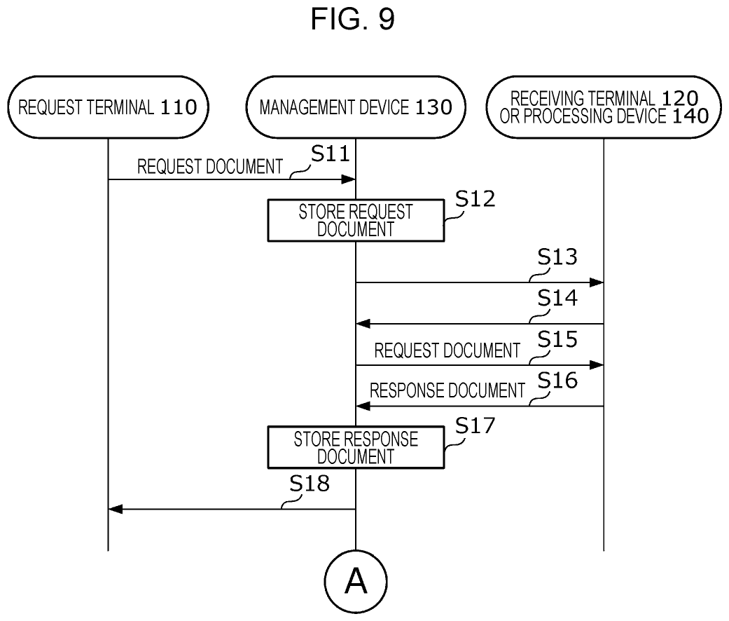

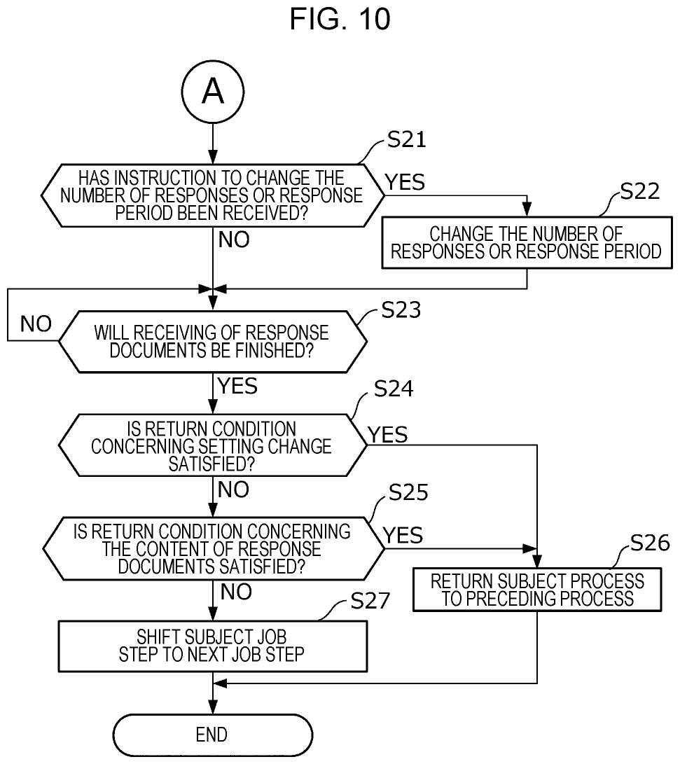

FIG. 9 is a sequence chart illustrating an example of processing executed by the management system 100 in each job step. FIG. 10 is a flowchart illustrating an example of processing executed by the management device 130 subsequent to the processing in FIG. 9. In step S11, the request terminal 110 sends a request document to the management device 130 in accordance with a requester operation performed on the operation unit 111. The management device 130 receives this request document by using the acquirer 331. In step S12, the management device 130 refers to the setting table 231 and stores the request document in the request folder 235 by using the acquirer 331. In the setting table 231 shown in FIG. 4, for example, the storage location of the request folder 235 in all the job steps is “http://www.AAA.example.com”. Accordingly, in all the job steps, a request document is stored in the request folder 235 at a location represented by the URL “http://www.AAA.example.com”.

In step S13, the management device 130 refers to the setting table 231 and informs the receiving terminal 120 or the processing device 140 of the storage location of the request document and that of a response document by using the informer 332. In the setting table 231 in FIG. 4, for example, if the email address of a receiver is indicated as the request executor of a subject job step, an email is sent to this email address. The body of this email shows the URL “http://www.AAA.example.com”, which is the storage location of the request folder 235, and the URL “http://www.BBB.example.com”, which is the storage location of the response folder 236. In step S14, the receiving terminal 120 or the processing device 140 accesses the storage location of the request document described in the information sent from the management device 130, and makes a request to receive the request document. In step S15, in response to the request from the receiving terminal 120 or the processing device 140, the management device 130 sends the request document stored in the request folder 235 to the receiving terminal 120 or the processing device 140. Then, the receiving terminal 120 or the processing device 140 receives the request document. The receiver using the receiving terminal 120 carries out work or the processing device 140 executes processing in accordance with the request document. For example, the receiver displays the request document on the display 122 of the receiving terminal 120 and reads the request document. The receiver then creates a response document by doing work based on the request made by the requester.

In step S16, the receiving terminal 120 or the processing device 140 sends the response document to the management device 130. This response document is addressed to the storage location described in the information sent from the management device 130, for example, to the URL “http://www.BBB.example.com”, for example. The management device 130 receives the response document by using the acquirer 331. In step S17, the management device 130 stores the response document in the response folder 236 of the storage 134 by using the acquirer 331. The response document is stored in the response folder 236 located at the URL “http://www.BBB.example.com”, for example. In step S18, by using the informer 332, the management device 130 informs the request terminal 110 that the response document is received. For example, the display controller 337 of the management device 130 sends display data for displaying the response document and a message that the response document is received to the request terminal 110, and the request terminal 110 displays the message and the response document on the management screen 400. After step S18, the management device 130 proceeds to step S21 in FIG. 10.

In step S21, the judger 335 judges whether an instruction to change the number of responses or the response period is received. It is possible that, during the process of a subject job step, the requester operates the request terminal 110 to provide an instruction to change the number of responses or the response period included in the setting table 231. For example, if the requester has performed an operation for providing an instruction to change the number of responses or the response period in the setting table 231 by using the operation unit 111, this instruction is sent from the request terminal 110 and is received by the acquirer 331 of the management device 130. In this case, the result of step S21 becomes YES, and the process proceeds to step S22. In step S22, the changer 334 changes the number of responses or the response period in the setting table 231 in accordance with the instruction. The process then proceeds to step S23.

If the judger 335 has judged in step S21 that an instruction to change the number of responses or the response period in the setting table 231 is not received, the process proceeds to step S23 by skipping step S22. In step S23, the judger 35 judges whether to finish receiving response documents. If response documents obtained from the receivers are fewer than the number of response documents of the subject job step described in the setting table 231 in FIG. 4, the result of step S23 becomes NO. If the response period of the subject job step described in the setting table 231 has not elapsed, the result of step S23 becomes NO. In either case, step S23 is repeated until the number of responses reaches that in the setting table 231 or the response period described in the setting table 231 elapses. In contrast, if the number of response documents obtained from receivers has reached that in the setting table 231, the result of step S23 becomes YES. If the response period described in the setting table 231 has elapsed, the result of step S23 becomes YES. The process then proceeds to step S24.

In step S24, the judger 335 judges by referring to the condition table 232 in FIG. 6A whether the return condition concerning a change in a setting in the subject job step is satisfied. For example, if the return condition of the subject job step included in the condition table 232 is satisfied, the result of step S24 becomes YES. The process then proceeds to step S26. In step S26, the shifting controller 336 makes a subject process return to a preceding process. For example, if the return condition of the subject job step included in the condition table 232 is satisfied, the associated return operation is performed. This makes the subject process return to a preceding process in the subject job step or the subject job step return to a preceding job step. If the return condition concerning a change in a setting in the subject job step is not satisfied, the result of step S24 becomes NO. The process then proceeds to step S25.

In step S25, the judger 335 refers to the condition table 233 in FIG. 6B to analyze the content of a response document, and judges whether the return condition concerning the content of the response document in the subject job step is satisfied. The content of the response document may be analyzed by using a known technique. If the return condition concerning the content of the response document in the subject job step is satisfied, the result of step S25 becomes YES. The process then proceeds to step S26, and the shifting controller 336 makes a subject process return to a preceding process, as discussed above. If the return condition of the subject job step included in the condition table 233 is satisfied, the associated return operation is performed. This makes the subject process return to a preceding process in the subject job step or the subject job step return to a preceding job step. If the return condition concerning the content of the response document in the subject job step is not satisfied, the result of step S25 becomes NO. The process then proceeds to step S27. In step S27, the shifting controller 336 shifts the subject job step to the next job step. For example, the subject job step shifts to the next job step among the job steps shown in FIG. 2. Specific examples of processing executed by the management system 100 and that by the management device 130 in the individual job steps in FIG. 2 will be described below with reference to FIGS. 9 and 10.

A specific example of processing in the creating step will first be discussed. In step S11 of FIG. 9, a request document for making a request to create the questionnaire draft 510 is sent from a requester. In the request document, a subject or a plan of the questionnaire 500 is described. In step S12, the request document is stored in the request folder 235. In step S13, information concerning the storage location of the storage folder 235 and that of the response folder 236 is supplied to the receiving terminal 120 of creator E, that is, the request executor of the creating step included in the setting table 231 in FIG. 4. In step S14, the receiving terminal 120 of the creator E accesses the request folder 235. In step S15, the request document is sent to the receiving terminal 120. The creator E creates the questionnaire draft 510 shown in FIG. 8, for example, in response to the request from the requester. In step S16, the questionnaire draft 510 is sent as a response document. In step S17, the questionnaire draft 510 is stored in the response folder 236. In step S18, the request terminal 110 is informed that the questionnaire draft 510 is received. For example, a message indicating that the questionnaire draft 510 is received is displayed in the display area 403 of the management screen 400 in FIG. 7. The questionnaire draft 510 may be displayed in the display area 403 in response to a requester operation.

In the setting table 231 shown in FIG. 4, the number of responses and the response period are not set for the creating step. In this case, steps S21 through S23 in FIG. 10 are skipped. In step S24, it is judged whether the return condition of the creating step included in the condition table 232 in FIG. 6A is satisfied. For example, in the questionnaire draft 510, the questionnaire items only up to question 4 are described. If the requester has made a change in the request document stored in the request folder 235 by using the operation unit 111 so as to make a request to add a new questionnaire item, which is question 5, and its answer field to the questionnaire draft 510, the return condition “questionnaire item is added” is satisfied. The process then proceeds to step S26, and the creating step is repeated. In this case, the creating step may be restarted from step S15 in FIG. 9, for example.

If it is judged in step S24 that the return condition of the creating step included in the condition table 232 in FIG. 6A is not satisfied, the process proceeds to step S25. In step S25, the questionnaire draft 510 is analyzed, for example, and it is judged whether the return condition of the creating step included in the condition table 233 shown in FIG. 6B is satisfied. In this case, the format of the questionnaire draft 510 is checked, for example, to determine whether it differs from the format of the questionnaire 500 included in the request made by the requester. For example, if only three questionnaire items are included in the questionnaire draft 510, while the requester has asked for four questionnaire items, the return condition “the content of response document does not conform to the content of request” included in the condition table 233 in FIG. 6B. The process then proceeds to step S26 and the creating step is repeated. In this case, the creator E may be informed of a portion of the response document which does not conform to the content of the request, and the creating step may be restarted from step S15 in FIG. 9, for example. If neither of the return condition of the creating step in the condition table 232 in FIG. 6A nor that in the condition table 233 in FIG. 6B is satisfied, the process proceeds to step S27, and the creating step proceeds to the next reviewing step.

A specific example of processing in the reviewing step will now be described below. In step S11 of FIG. 9, a request document for making a request to review the questionnaire draft 510 is sent from a requester. The request document may include an instruction to execute this request and the questionnaire draft 510 created in the creating step. The request document may alternatively include only this instruction. In this case, the requester may perform an operation for providing an instruction to execute a review request by using the operation unit 111 so as to send this instruction as a request document. In step S12, the request document is stored in the request folder 235. In step S13, information concerning the storage location of the storage folder 235 and that of the response folder 236 is supplied to the receiving terminals 120 of reviewers H, I, J, and K, that is, the request executors in the reviewing step included in the setting table 231 in FIG. 4. In step S14, the receiving terminals 120 of the reviewers H through K access the request folder 235. In step S15, the request document is sent to these receiving terminals 120. This request document includes the questionnaire draft 510.

The reviewers H through K review the questionnaire draft 510 in response to the request from the requestor. The reviewers H through K may add a correction 512 or a comment 513 to the questionnaire draft 510, for example, as shown in the middle section of FIG. 8. In step S16, the review result is sent as a response document. If neither of a correction 512 nor a comment 513 is added to the questionnaire draft 510, the questionnaire draft 510 in the request document is included in the review result. If a correction 512 or a comment 513 is added to the questionnaire draft 510, the questionnaire draft 510 with the correction 512 or the comment 513 is included in the review result, as shown in the middle section of FIG. 8. In step S17, the review result is stored in the response folder 236. In step S18, the request terminal 110 is informed that the review result is received. For example, a message indicating that the review result is received is displayed in the display area 403 of the management screen 400 in FIG. 7. The questionnaire draft 510 included in the review result may be displayed in the display area 403 in response to a requester operation.

In step S21 of FIG. 10, it is judged whether an instruction to change the number of responses or the response period of the reviewing step included in the setting table 231 in FIG. 4 is received. If such an instruction is received, the process proceeds to step S22. In step S22, the number of responses or the response period of the reviewing step is changed in accordance with this instruction. If it is found in step S21 that an instruction to change the number of responses or the response period is not received, the process proceeds to step S23 to judge whether to finish receiving response documents. If the number of items of review results, that is, the number of responses of the reviewing step included in the setting table 231 in FIG. 4, has reached two or if ten days, which are the response period of the reviewing step included in the setting table 231 in FIG. 4, has elapsed, the process proceeds to step S24. It is judged in step S24 whether the return condition of the reviewing step included in the condition table 232 in FIG. 6A is satisfied. For example, if reviewers L and M are added, the return condition “reviewers are changed” is satisfied, and the process proceeds to step S26. The reviewing step is repeated for the reviewers L and M. In this case, the reviewing step may be restarted from step S13 in FIG. 9.

If it is judged in step S24 that the return condition of the reviewing step included in the condition table 232 is not satisfied, the process proceeds to step S25. In step S25, the review result is analyzed, for example, and it is judged whether the return condition of the reviewing step included in the condition table 233 in FIG. 6B is satisfied. More specifically, it is determined whether the questionnaire draft 510 included in the review result differs from that included in the request document. If it is found that the two questionnaire drafts 510 are different from each other, it means that a correction 512 or a comment 513 is added to the questionnaire draft 510. If a correction 512 or a comment 513 is added to the questionnaire draft 510, as shown in the middle section of FIG. 8, the return condition “comment or correction is added” described in the condition table 233 is satisfied. The process then proceeds to step S26, and the reviewing step returns to the creating step. In this case, the requester may make a change in the request document in accordance with the correction 512 or the comment 513 made by a reviewer, and the creating step may be restarted from step S11 in FIG. 9. If neither of the return condition of the reviewing step in the condition table 232 in FIG. 6A nor that in the condition table 233 in FIG. 6B is satisfied, the process proceeds to step S27, and the reviewing step proceeds to the next approving step.

A specific example of processing in the approving step will now be described below. In step S11 of FIG. 9, a request document for making a request to approve the questionnaire draft 510 is sent from a requester. The request document may include an instruction to execute an approval request and the questionnaire draft 510 subjected to the reviewing step. The request document may alternatively include only this instruction. In this case, as in the reviewing step, the requester may perform an operation for providing an instruction to execute the approval request by using the operation unit 111 so as to send this instruction as a request document. In step S12, the request document is stored in the request folder 235. In step S13, information concerning the storage location of the storage folder 235 and that of the response folder 236 is supplied to the receiving terminal 120 of approver X, which is the first approver of approvers X and Y, that is, request executors of the approving step included in the setting table 231 in FIG. 4. In step S14, the receiving terminal 120 of the approver X accesses the request folder 235. In step S15, the request document is sent to this receiving terminal 120. This request document includes the reviewed questionnaire draft 510.

The approver X determines whether to approve the questionnaire draft 510 in response to the request from the requestor. If the approver X approves the questionnaire draft 510, it places a seal of the approver X in the seal field 511 of the questionnaire draft 510 shown in FIG. 8. If the approver X does not approve the questionnaire draft 510, it does not place a seal of the approver X in the seal field 511. In this case, the approver X may add a comment 513, such as that shown in FIG. 8, to the questionnaire draft 510. In step S16, the approval result is sent as a response document. If the questionnaire draft 510 is approved, the questionnaire draft 510 appended with an approval seal is included in the approval result. If the questionnaire draft 510 is not approved, the questionnaire draft 510 without an approval seal is included in the approval result. A comment 513 may be added to the questionnaire draft 510 without an approval seal. In step S17, the approval result is stored in the response folder 236. In step S18, the request terminal 110 is informed that the approval result is received. For example, a message indicating that the approval result is received is displayed in the display area 403 of the management screen 400 in FIG. 7. The questionnaire draft 510 included in the approval result may be displayed in the display area 403 in response to a requester operation.

In the setting table 231 shown in FIG. 4, the number of responses and the response period are not set for the approving step. In this case, steps S21 through S23 in FIG. 10 are skipped. In step S24, it is judged whether the return condition of the approving step included in the condition table 232 in FIG. 6A is satisfied. For example, if approver Z is added, the return condition “approvers are changed” is satisfied. The process then proceeds to step S26 and the approving step is repeated for the approver Z. In this case, the approving step may be restarted from step S13 in FIG. 9, for example.

If it is judged in step S24 that the return condition of the approving step included in the condition table 232 in FIG. 6A is not satisfied, the process proceeds to step S25. In step S25, the approval result is analyzed, for example, and it is judged whether a return condition of the approving step included in the condition table 233 in FIG. 6B is satisfied. More specifically, the content of the questionnaire draft 510 included in the approval result is checked, and it is determined whether an approval seal is included in the questionnaire draft 510. It is also determined whether the questionnaire draft 510 included in the approval result differs from that included in the request document. If it is found that the two questionnaire drafts 510 are different from each other, it means that a comment 513 is added to the questionnaire draft 510. If a comment 513 is added to the questionnaire draft 510, for example, the return condition “comment is added” included in the condition table 233 is satisfied. The process then proceeds to step S26, and the reviewing step returns to the creating step. In this case, the requester may make a change in the request document in accordance with the comment 513 made by the first approver, and the creating step may be restarted from step S11. If an approval seal is added to the questionnaire draft 510, the return condition “approval seal is placed (there is another approver)” included in the condition table 233 is satisfied. The process then proceeds to step S26, and the approving step is repeated for the next approver Y. In this case, the approving step may be restarted from step S13 of FIG. 9. If neither of the return condition of the approving step in the condition table 232 in FIG. 6A nor that in the condition table 233 in FIG. 6B is satisfied, the process proceeds to step S27, and the approving step proceeds to the next distributing step. In this case, the questionnaire 500 is created based on the approved questionnaire draft 510.

A specific example of processing in the distributing step will now be described below. In step S11 of FIG. 9, a request document for making a request to complete the questionnaire 500 is sent from a requester. The request document may include the questionnaire 500 shown in the right section of FIG. 8, for example. In step S12, the request document is stored in the request folder 235. In step S13, information concerning the storage location of the storage folder 235 and that of the response folder 236 is supplied to the receiving terminals 120 of distribution subjects, that is, the request executors in the distributing step included in the setting table 231 in FIG. 4. In step S14, the receiving terminals 120 of the distribution subjects access the request folder 235. In step S15, the request document is sent to these receiving terminals 120. Each distribution subject completes the questionnaire 500 in response to the request from the requester. In step S16, completed questionnaires in response to the questionnaire 500 are sent as response documents. In step S17, the completed questionnaires are stored in the response folder 236. In step S18, the request terminal 110 is informed that completed questionnaires are received in response to the questionnaire 500. For example, a message indicating that completed questionnaires are received is displayed in the display area 403 of the management screen 400 in FIG. 7. Completed questionnaires may be displayed in the display area 403 in response to a requester operation.

In step S21 of FIG. 10, it is judged whether an instruction to change the number of responses or the response period of the distributing step included in the setting table 231 in FIG. 4 is received. If such an instruction is received, the process proceeds to step S22. In step S22, the number of responses or the response period of the distributing step is changed in accordance with the instruction. If it is found in step S21 that an instruction to change the number of responses or the response period is not received, the process proceeds to step S23 to judge whether to finish receiving completed questionnaires. If the number of completed questionnaires in response to the questionnaire 500, that is, the number of responses of the distributing step included in the setting table 231, has reached ten or if one month, which is the response period of the distributing step included in the setting table 231, has elapsed, the process proceeds to step S24. It is judged in step S24 whether the return condition of the distributing step included in the condition table 232 in FIG. 6A is satisfied. For example, if a new distribution subject is added, the return condition “distribution subjects are changed” is satisfied, and the process proceeds to step S26. The distributing step is repeated for the new distribution subject. In this case, the distributing step may be restarted from step S13 of FIG. 9.

If it is judged in step S24 that the return condition of the distributing step included in the condition table 232 in FIG. 6A is not satisfied, the process proceeds to step S25. In step S25, the completed questionnaires in response to the questionnaire 500 are analyzed, for example, and it is judged whether the return condition of the distributing step included in the condition table 233 in FIG. 6B is satisfied. If the return condition is satisfied, the process proceeds to step S26, and the corresponding return operation is performed. If neither of the return condition of the distributing step in the condition table 232 in FIG. 6A nor that in the condition table 233 in FIG. 6B is satisfied, the process proceeds to step S27, and the distributing step proceeds to the next aggregating step.

A specific example of processing in the aggregating step will now be described below. In step S11 of FIG. 9, a request document for making a request to aggregate completed questionnaires based on the questionnaire 500 is sent from a requester. The request document includes the completed questionnaires received in the distributing step. In step S12, the request document is stored in the request folder 235. In step S13, information concerning the storage location of the storage folder 235 and that of the response folder 236 is supplied to the processing device 140, that is, the request executor of the aggregating step included in the setting table 231 in FIG. 4. In step S14, the processing device 140 accesses the request folder 235. In step S15, the request document is sent to the processing device 140. The processing device 140 executes processing for aggregating the completed questionnaires. In step S16, the aggregation result is sent as a response document. In step S17, the aggregation result is stored in the response folder 236. In step S18, the request terminal 110 is informed that the aggregation result is received. For example, a message indicating that the aggregation result is received is displayed in the display area 403 of the management screen 400 in FIG. 7. The aggregation result may be displayed in the display area 403 in response to a requester operation.

In the setting table 231 shown in FIG. 4, the number of responses and the response period are not set for the aggregating step. In this case, steps S21 through S23 in FIG. 10 are skipped. In step S24, it is judged whether the return condition of the aggregating step included in the condition table 232 in FIG. 6A is satisfied. For example, if a new completed questionnaire in response to the questionnaire 500 is added as a result of the number of responses or the response period of the distributing step included in the setting table 231 being changed, the return condition “completed questionnaire is added” is satisfied. The process then proceeds to step S26, and the aggregating step is repeated for the new completed questionnaire. In this case, the aggregating step may be restarted from step S11 in FIG. 9, for example.

If it is judged in step S24 that the return condition of the aggregating step included in the condition table 232 is not satisfied, the process proceeds to step S25. In step S25, the aggregation result is analyzed, for example, and it is judged whether the return condition of the aggregating step included in the condition table 233 in FIG. 6B is satisfied. If the return condition is satisfied, the process proceeds to step S26, and the corresponding return operation is performed. If neither of the return condition of the aggregating step in the condition table 232 in FIG. 6A nor that in the condition table 233 in FIG. 6B is satisfied, the process proceeds to step S27, and the aggregating step proceeds to the next feedback step.

A specific example of processing in the feedback step will now be described below. In step S11 of FIG. 9, a request document is sent to the management device 130 from a requester. The request document includes the aggregation result obtained in the aggregating step. In step S12, the request document is stored in the request folder 235. In step S13, information concerning the storage location of the storage folder 235 is supplied to the receiving terminal 120 of a feedback subject, that is, the request executor of the feedback step included in the setting table 231 in FIG. 4. In step S14, the receiving terminal 120 of the feedback subject accesses the request folder 235. In step S15, the request document is sent to the receiving terminal 120. In the feedback step, the receiver does not respond to the request document, and steps S16 through S18 of FIG. 9 are thus skipped. In the setting table 231 shown in FIG. 4, the number of responses and the response period are not set for the feedback step. Steps S21 through S23 in FIG. 10 are thus skipped.

In step S24 of FIG. 10, it is judged whether the return condition of the feedback step included in the condition table 232 in FIG. 6A is satisfied. For example, if the requester performs an operation for making a change in the request document stored in the request folder 235 and used in the creating step by using the operation unit 111 so as to make a request to add two questionnaire items to the questionnaire 500 in FIG. 8, the return condition “questionnaire item is added” is satisfied. The process then proceeds to step S26, and the feedback step returns to the creating step. In this case, the creating step may be restarted from step S15 in FIG. 9, for example. If it is judged in step S24 that the return condition of the feedback step included in the condition table 232 is not satisfied, the processing is terminated. This is because, in the feedback step, the receiver does not respond to the request document, as discussed above, and the feedback step is the final step. Steps S25 through S27 in FIG. 10 are thus skipped. As a result, a job for carrying out the questionnaire 500 has been completed.

The association between the following elements of the above-described exemplary embodiment and those in an exemplary embodiment of the disclosure is as follows. The request terminal 110 corresponds to a first terminal device. The receiving terminal 120 corresponds to a second terminal device. A return condition concerning the content of a response document corresponds to a first return condition. A return condition concerning a change in a setting corresponds to a second return condition. A requester or a receiver corresponds to an operator.

In the above-described exemplary embodiment, the management device 130 judges whether a condition for shifting a subject job step to another job step is satisfied. The subject job step thus shifts to another job step without an operator judging whether the condition is satisfied. When a job step has shifted to a preceding or subsequent job step, documents are exchanged based on settings set for the preceding or subsequent job step under the control of the management device 130.

If a return condition concerning the content of a response document is satisfied, a subject process returns to a preceding process in a subject job step or the subject job step returns to a preceding job step. If the return condition concerning the content of a response document is not satisfied, the subject job step shifts to the subsequent job step without a requester judging whether this return condition is satisfied.

If a return condition concerning a change in a setting is satisfied, a subject process returns to a preceding process in a subject job step or the subject job step returns to a preceding job step. If the return condition concerning a change in a setting is not satisfied, the subject job step shifts to the subsequent job step without a requester judging whether this return condition is satisfied.

If the number of responses or a response period is set in a subject job step, the subject job step does not shift to another job step until the number of response documents reaches a predetermined number or a predetermined response period elapses.

The progress situation of job steps is displayed in the display area 402 of the management screen 400, as shown in FIG. 7, thereby enabling a requester to check the progress situation of a job. Additionally, a judging result of a return condition concerning the content of a response document is displayed in the display area 404 of the management screen 400, and a list of return conditions concerning a change in a setting is displayed in the display area 405 of the management screen 400, thereby enabling a requester to identify a condition for shifting to a subsequent job step.

### 3. Modified Examples

The above-described exemplary embodiment is only an example, and the present disclosure is not restricted thereto. The exemplary embodiment may be modified in the following manner. Two or more of the following modified examples may be combined and carried out.

In the above-described exemplary embodiment, the content of each job step is not restricted to the above-described example. For example, a collecting step of collecting reference documents may be included in the creating step. In this case, the request terminal 110 sends a request document for making a request to collect reference documents. A search condition of reference documents may be described in the request document. The receiving terminal 120 returns a collecting result as a response document. The collecting result may include reference documents. The condition table 232 may include a return condition of the collecting step and the associated return operation. For example, the return condition that the request document is not a document of the latest version may be provided. As the return operation, the collecting step may be repeated. If the request document is not a document of the latest version, the collecting step may be repeated after a request document of the latest version is received. The return condition that a search condition of reference documents is added may also be provided. As the associated return operation, the collecting step may be repeated. If a search condition is added as a result of making a change in the request document stored in the request folder 235, the collecting step may be repeated.

In the above-described exemplary embodiment, the content of the condition tables 232 and 233 is not restricted to the above-described examples. A return condition concerning a change in a setting of each job step may include a condition that a request executor is changed or a condition that a storage location is changed. That is, a return condition concerning a change in a setting may be any condition as long as it concerns a change in a setting and it is desirable to make a subject process return to a preceding process in a subject job step or the subject job step return to a preceding job step instead of shifting to the subsequent job step if this condition is satisfied. As a return condition concerning the content of a response document in the approving step, a condition that the date of an approval seal is wrong or that the area where an approval seal is placed is wrong may also be provided. In this case, as the associated return operation, the approving step is repeated for the same approver. That is, a return condition concerning the content of a response document may be any condition as long as it concerns the content of a response document and it is desirable to make a subject process return to a preceding process in a subject job step or the subject job step return to a preceding job step instead of shifting to the subsequent job step if this condition is satisfied. Instead of a return condition, an advance condition for making a subject job step proceed to a subsequent job step may be used. In this case, an advance condition may be a condition which negates the corresponding return condition. Additionally, one of the return condition concerning a change in a setting and that concerning the content of a response document may be omitted.

In the above-described exemplary embodiment, the content of the setting table 231 is not restricted to the above-described example. For example, the setting table 231 may describe how to send and receive documents. That is, a setting included in the setting table 231 may be any setting if it concerns the format for exchanging documents and also concerns processing executed by the management device 130 to exchange documents between the request terminal 110 and the receiving terminal 120.

In the above-described exemplary embodiment, a job carried out by a requester is not limited to a job concerning the questionnaire 500. The requester may be in charge of a job for issuing invoices or submitting any kind of document to outsiders. That is, a job may be any type of job if it is implemented as a result of exchanging documents between a requester and a receiver. Additionally, at least some of the above-described job steps may be omitted or changed or a new job step may be added in accordance with the content of a job.

In the above-described exemplary embodiment, a medium for communicating information is not limited to email. For example, if a receiver is registered in advance, the management screen 400 is displayed on the receiving terminal 120, as well as on the request terminal 110. In this case, information may be communicated as a result of displaying a message on the management screen 400. The progress situation of a job and return conditions are also displayed on the receiving terminal 120, so that, not only a requester, but also a receiver, is able to recognize the progress situation of a job and a condition for shifting a subject job step to a subsequent job step.

In the above-described exemplary embodiment, in the second and subsequent job steps, steps S11 and S12 in FIG. 9 may be omitted. In this case, when a preceding job step has finished, the process of a subject job step proceeds to step S13. A request document stored in the request folder 235 is sent to the receiving terminal 120 or the processing device 140, and a response document stored in the response folder 236 is sent to the terminal device 110. That is, in the second and subsequent job steps, a job request can be made without intervention of a requester.

In the above-described exemplary embodiment, the content of processing executed by the processing device 140 is not restricted to processing for aggregating completed questionnaires based on the questionnaire 500. The processing device 140 may execute any type of processing based on a request, such as processing for collecting information concerning reference documents and character recognition processing.

In the above-described exemplary embodiment, the configurations of the management system 100, the request terminal 110, the receiving terminal 120, the management device 130, and the processing device 140 are not restricted to the above-described examples. For example, plural request terminals 110, management devices 130, and/or processing devices 140 may be provided. The management device 130 is not limited to a cloud server, but may be an on-premises server. The elements for implementing the functions of the management system 100 are not restricted to the above-described examples. For example, some functions of the management device 130 may be implemented by another device.

In the above-described exemplary embodiment, processing steps executed by the management system 100, the request terminal 110, the receiving terminal 120, the management device 130, and the processing device 140 are not restricted to the above-described examples. The processing steps may be replaced by each other unless they are inconsistent with each other. For example, steps S21, S22, and S24 in FIG. 10 may be executed before a response document is received.

The present disclosure may be implemented as a method including processing steps executed by the management system 100, the request terminal 110, the receiving terminal 120, the management device 130, or the processing device 140.

The present disclosure may be implemented as a program executed by the request terminal 110, the receiving terminal 120, the management device 130, or the processing device 140. The program may be downloaded via a communication network, such as the Internet. The program may be provided as a result of being recorded in a computer-readable recording medium, such as a magnetic recording medium (magnetic tape and a magnetic disk, for example), an optical recording medium (an optical disc, for example), a magneto-optical recording medium, or a semiconductor memory.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A management device comprising:
an acquirer that acquires, in a subject job step included in a plurality of job steps, a response document or an instruction to change a setting of a format used for exchanging documents in the subject job step, a request being made and a response to the request being returned as a result of exchanging documents in each job step, the response document being used as the response; and
a shifting controller that performs control to shift the subject job step to another job step in accordance with a condition concerning a change in the setting based on the instruction or a condition concerning content of the response document.

2. The management device according to claim 1, wherein:
the acquirer acquires the response document;
the condition includes a first return condition concerning the content of the response document; and
if the first return condition is not satisfied, the shifting controller shifts the subject job step to a subsequent job step.

3. The management device according to claim 1, wherein:
the acquirer acquires the response document;
the condition includes a first return condition concerning the content of the response document; and
if the first return condition is satisfied, the shifting controller repeats the subject job step or shifts the subject job step to a preceding job step.

4. The management device according to claim 2, wherein:
the acquirer acquires the response document;
the condition includes a first return condition concerning the content of the response document; and
if the first return condition is satisfied, the shifting controller repeats the subject job step or shifts the subject job step to a preceding job step.

5. The management device according to claim 2, wherein the first return condition is a condition indicating that the content of the response document does not conform to content of the request or that the document needs changing.

6. The management device according to claim 3, wherein the first return condition is a condition indicating that the content of the response document does not conform to content of the request or that the document needs changing.

7. The management device according to claim 4, wherein the first return condition is a condition indicating that the content of the response document does not conform to content of the request or that the document needs changing.

8. The management device according to claim 1, wherein:
the acquirer acquires the instruction;
the condition includes a second return condition indicating that a change is made in the setting; and
if the second return condition is not satisfied, the shifting controller shifts the subject job step to a subsequent job step.

9. The management device according to claim 2, wherein:
the acquirer acquires the instruction;
the condition includes a second return condition indicating that a change is made in the setting; and
if the second return condition is not satisfied, the shifting controller shifts the subject job step to a subsequent job step.

10. The management device according to claim 1, wherein:
the acquirer acquires the instruction;
the condition includes a second return condition indicating that a change is made in the setting; and
if the second return condition is satisfied, the shifting controller repeats the subject job step or shifts the subject job step to a preceding job step.

11. The management device according to claim 2, wherein:
the acquirer acquires the instruction;
the condition includes a second return condition indicating that a change is made in the setting; and
if the second return condition is satisfied, the shifting controller repeats the subject job step or shifts the subject job step to a preceding job step.

12. The management device according to claim 8, wherein:
the acquirer also acquires the response document;
the setting includes a setting concerning a predetermined number of responses or a response period; and
if the acquired response document is fewer than the predetermined number of responses or if the response period has not elapsed, the shifting controller continues the subject job step.

13. The management device according to claim 10, wherein:
the acquirer also acquires the response document;
the setting includes a setting concerning a predetermined number of responses or a response period; and
if the acquired response document is fewer than the predetermined number of responses or if the response period has not elapsed, the shifting controller continues the subject job step.

14. The management device according to claim 1, further comprising:
a display controller that performs control to display a progress situation of a job on a terminal device used by an operator making the request or the response, the job being conducted in accordance with the plurality of job steps.

15. The management device according to claim 2, further comprising:
a display controller that performs control to display a progress situation of a job on a terminal device used by an operator making the request or the response, the job being conducted in accordance with the plurality of job steps.

16. The management device according to claim 1, further comprising:
a display controller that performs control to display information indicating the condition on a terminal device used by an operator making the request or the response.

17. The management device according to claim 2, further comprising:
a display controller that performs control to display information indicating the condition on a terminal device used by an operator making the request or the response.

18. A management system comprising:
a first terminal device that sends a request document in a subject job step included in a plurality of job steps, a request being made and a response to the request being returned as a result of exchanging documents in each job step, the request document being used for making the request;
a second terminal device that sends a response document in the subject job step, the response document being used for making the response; and
a management device that receives the request document from the first terminal device and provides the received request document to the second terminal device and that receives the response document from the second terminal device and provides the received response document to the first terminal device,
the management device including
an acquirer that acquires the response document or an instruction to change a setting of a format used for exchanging the request document and the response document in the subject job step, and
a shifting controller that performs control to shift the subject job step to another job step in accordance with a condition concerning a change in the setting based on the instruction or a condition concerning content of the response document.

19. A non-transitory computer readable medium storing a program causing a computer to execute a process, the process comprising:
acquiring, in a subject job step included in a plurality of job steps, a response document or an instruction to change a setting of a format used for exchanging documents in the subject job step, a request being made and a response to the request being returned as a result of exchanging documents in each job step, the response document being used as the response; and
performing control to shift the subject job step to another job step in accordance with a condition concerning a change in the setting based on the instruction or a condition concerning content of the response document.
